(19) United States
(12) Patent Application Publication
(10) Pub. No.: US 2016/0048367 A1
(43) Pub. Date: Feb. 18, 2016

(54) Method for Wirelessly Connecting A Computer To A Monitor For Video Display

(71) Applicant: Johnny Chen, Taipei City (TW)

(72) Inventor: Johnny Chen, Taipei City (TW)

(73) Assignee: I/O INTERCONNECT INC., Taipei City (TW)

(21) Appl. No.: 14/457,131

(22) Filed: Aug. 12, 2014

(51) Int. Cl. G06F 3/14; H04N 5/44

(52) U.S. Cl. CPC G06F 3/1454; G06F 3/1423; H04N 5/44

(57) ABSTRACT

The method includes the steps of: a) connecting a dongle to a monitor; b) creating a Wi-Fi connection between the dongle and a computer; c) the dongle sending an application to the computer; d) the computer running the application; e) the application detecting the computer; f) creating a wireless screencasting connection between the computer and the dongle when the computer has a wireless screencasting function; g) after the step f), the application capturing a screen of the computer and sends data of the screen to the dongle through the wireless screencasting connection; h) after the step e), the application capturing a screen of the computer and sending data of the screen to the dongle through the wireless data connection when the computer does not have a wireless screencasting function; and i) after the step g) or h), the dongle sending the data of the screen to the monitor.

### BACKGROUND OF THE INVENTION

1. Technical field

The invention relates to screen mirroring technology, particularly to wireless screen mirroring technology without depending upon existing industrial standards of wirelessly screen mirroring.

2. Related Art

Portable computers, such as smartphones and tablet computers, almost become necessary for every person in the world. Many people are involved in surfing internet or networking communication by using portable computers. Also, some users want to echo an image of his or her portable computer onto a large-sized monitor such as a TV set when he or she is at home or office because the large-sized monitor is far easier to browse than a portable computer's built-in small-sized screen.

Currently, there are wireless screencasting standards, such as Miracst, which enable wireless delivery of audio and video to or from desktops, tablets, mobile phones, and other devices. They allow users to, for example, echo display from a phone or tablet onto a TV set, share a laptop screen with the conference room projector in real-time, and watch live programs from a home cable box on a tablet. Such a wireless screencasting standard can be used, but it requires that both the sending and receiving devices must support the same standard (such as Miracast) for the technology to work. However, not all computers support the same standard. The wireless standard cannot be available if either of computer and monitor does not support the standard. When a wireless connection between a computer and a monitor is unavailable, users must use a cable to connect both. In other words, a wired connection is unavoidable. You can imagine it is very inconvenient.

### SUMMARY OF THE INVENTION

An object of the invention is to provide a method for wireless connecting a computer to a monitor for video display, which can create wirelessly screen mirroring without depending upon any existing industrial standards of wirelessly screen mirroring.

To accomplish the above object, the method of the invention includes the steps of: a) connecting a dongle to a monitor; b) creating a Wi-Fi connection between the dongle and a computer; c) the dongle sending an application to the computer; d) the computer running the application; e) the application detecting the computer; f) creating a wireless screencasting connection between the computer and the dongle when the computer has a wireless screencasting function; g) after the step f), the application capturing a screen of the computer and sends data of the screen to the dongle through the wireless screencasting connection; h) after the step e), the application capturing a screen of the computer and sending data of the screen to the dongle through the wireless data connection when the computer does not have a wireless screencasting function; and i) after the step g) or h), the dongle sending the data of the screen to the monitor.

### BRIEF DESCRIPTION OF THE DRAWINGS

FIG. 1 is a schematic view of systematical arrangement of the invention; and

FIG. 2 is an upper part of a flowchart of the invention;

FIG. 3 is a lower part of the flowchart of a first embodiment of the invention; and

FIG. 4 is a lower part of the flowchart of a second embodiment of the invention.

### DETAILED DESCRIPTION OF THE INVENTION

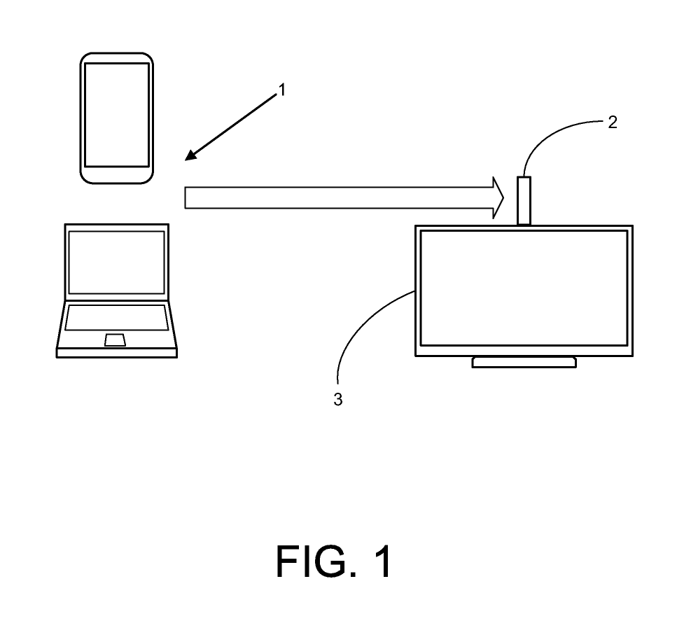

Please refer to FIG. 1. To perform the method of the invention, a dongle 2 is required. The dongle 2 may be shaped like a flash drive with a VGA (Video Graphics Array, also known as D-sub) or HDMI (High-Definition Multimedia Interface) connector. The computer 1 to be connected to a monitor 3 may be a desktop, a laptop, a smartphone or a tablet computer. The monitor 3 may be a TV set with an HDMI port or a VGA port. The dongle 2 is connected to the monitor 3 through a VGA or HDMI port. The dongle 2 is provided with a wireless data connection function such as Wi-Fi so that a wireless data connection can be established between the computer 1 and the dongle 2. Data can be transferred between the computer 1 and the dongle 2 and the dongle can send data to the monitor 3 so that an image of the computer 1 can be echoed onto the monitor 3 through the dongle 2.

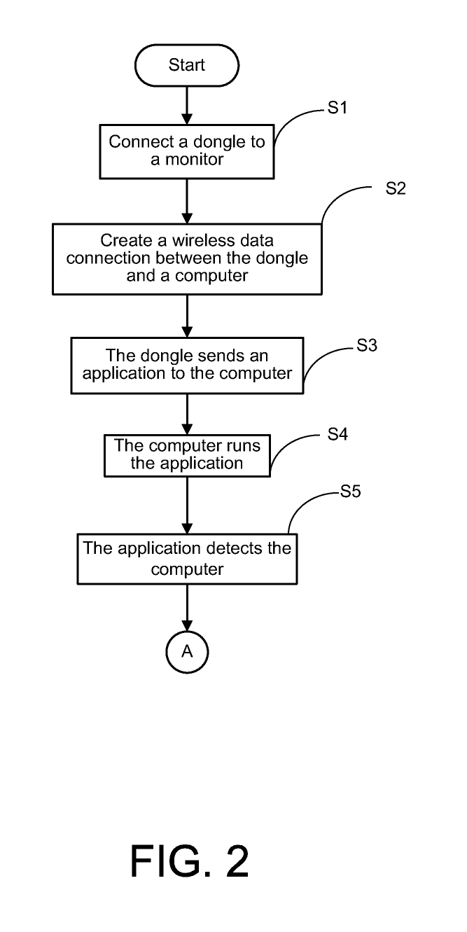

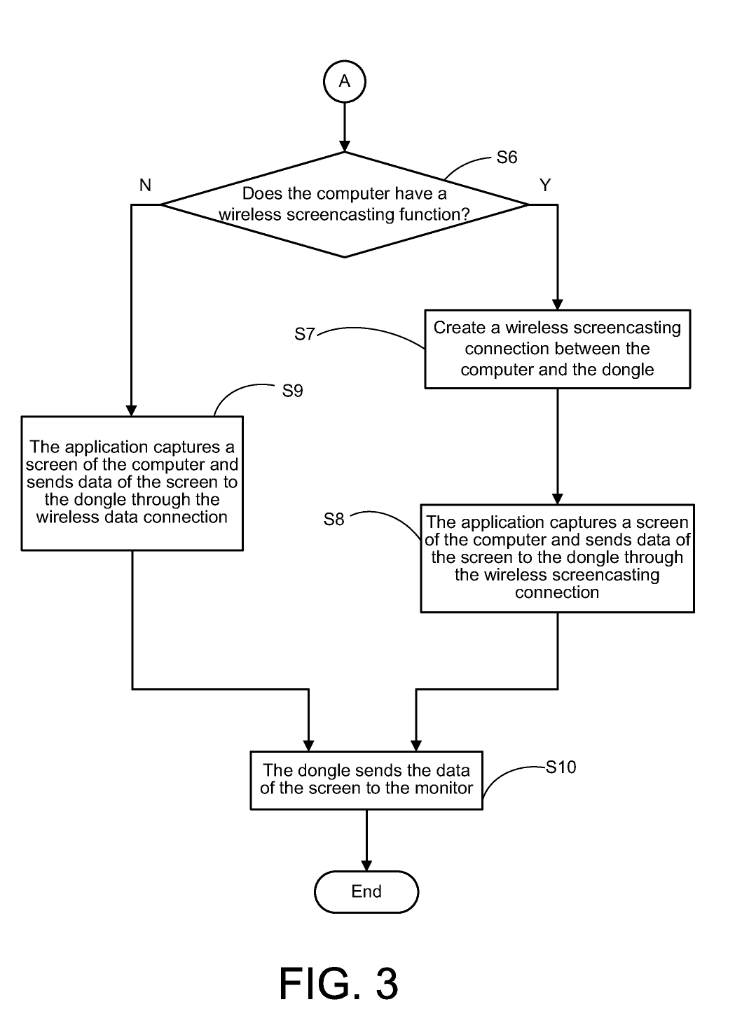

Please refer to FIGS. 2 and 3, which show a flowchart of a first embodiment of the method of the invention. In step S1, the dongle 2 is connected to the monitor 3. In step S2, a wireless data connection, such as Wi-Fi, is created between the dongle 2 and the computer 1. In step S3, the dongle 2 wirelessly sends an application to the computer 1 through the wireless data connection. The step S3 is triggered by a user's operation. In detail, after the steps S1 and S2 have been finished, the dongle 2 inputs an image of user interface (UI) to the monitor 3 to show, then a user can operate the UI to perform the step S3. In step S4, the computer 1 runs the application after the step S3. In steps S5 and S6, the application detects functionality of the computer 1 to check if the computer 1 has a wireless screencasting function or not. The wireless screencasting function may be the Miracast, Wi-Di (Wireless Display) or Screen Mirroring standard. When the computer 1 has a wireless screencasting function, a wireless screencasting connection is created between the computer 1 and the dongle 2 in step S7 and the application captures a screen of the computer and sends data of the screen to the dongle 2 through the wireless screencasting connection in step S8. Steps S6-9 can be performed automatically or manually. In the automatic mode, the application spontaneously executes this step. In the manual mode, the application shows a menu of options on a display of the computer 1 to illustrate steps about how to build wireless connection between the computer 1 and dongle 2 so that a user can manually operate and select one or more options he or she wants. In step S9, the application captures a screen of the computer and sends data of the screen to the dongle 2 through the wireless data connection when the computer 1 does not have a screencasting function. In step S10, the dongle 2 sends the data of the screen to the monitor 3 so that the monitor 3 can echo the screen of the computer 1.

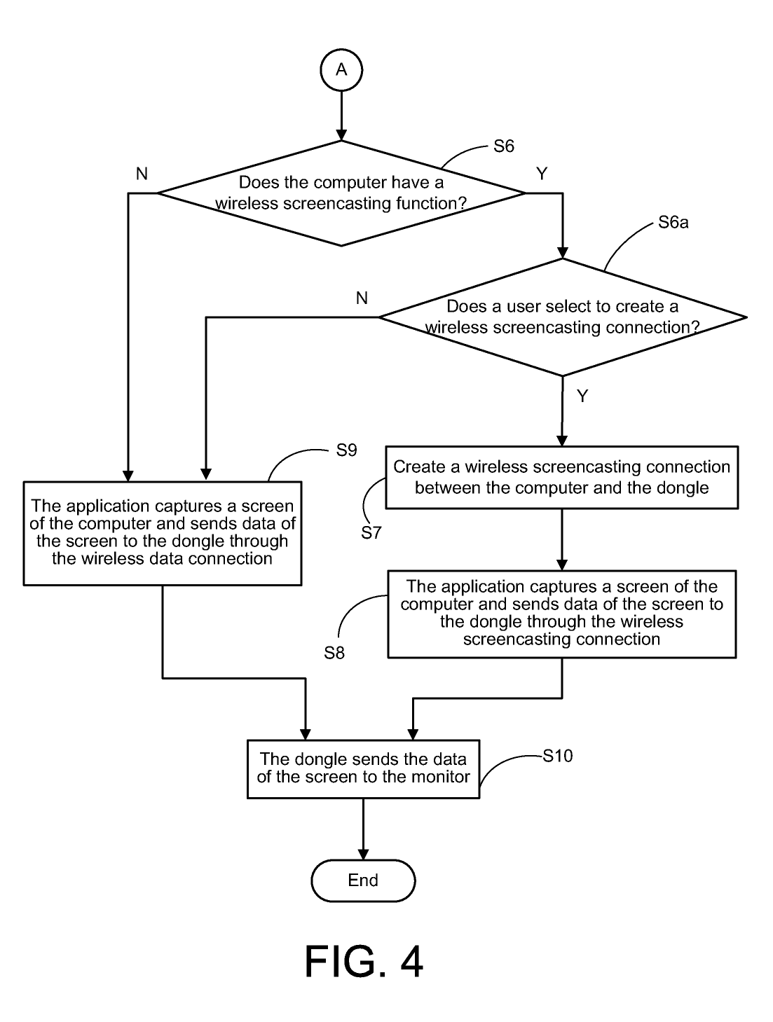

Please refer to FIG. 4, which show a flowchart of a second embodiment of the method of the invention. In this embodiment, steps S1-S6 are the same as the first embodiment abovementioned. After the application detects functionality of the computer 1 to check if the computer 1 has a wireless screencasting function or not in step S6, a step S6a is added. When the computer 1 has a wireless screencasting function, a user may further select to create a wireless screencasting connection between the computer 1 and the dongle 2 or to still use the wireless data connection in step S6a. If the user selects to create a wireless screencasting connection, a wireless screencasting connection is created between the computer 1 and the dongle 2 in step S7 and the application captures a screen of the computer and sends data of the screen to the dongle 2 through the wireless screencasting connection in step S8. Steps S6-S9 are performed manually. The application shows a menu of options on a display of the computer 1 to illustrate steps about how to build wireless connection between the computer 1 and dongle 2 so that a user can manually operate and select one or more options he or she wants. In step S9, the application captures a screen of the computer and sends data of the screen to the dongle 2 through the wireless data connection when the computer 1 does not have a screencasting function or a user selects to use the wireless data connection for screencasting. In step S10, the dongle 2 sends the data of the screen to the monitor 3 so that the monitor 3 can echo the screen of the computer 1.

By implementing the method of the invention, a user can easily implement screencasting from a computer to a monitor without depending upon any existing industrial standard of wirelessly screen mirroring such as Miracast or Wi-Di (Wireless Display). When a user's computer or monitor does not support an existing industrial standard of wirelessly screen mirroring, he or she still can perform wirelessly screen mirroring. This is very useful and helpful for users whose computer or monitor does not support an existing industrial standard of wirelessly screen mirroring.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for wirelessly connecting a computer to a monitor, comprising the steps of:
a) connecting a dongle to a monitor;
b) creating a wireless data connection between the dongle and a computer;
c) the dongle sending an application to the computer;
d) the computer running the application;
e) the application detecting the computer;
f) creating a wireless screencasting connection between the computer and the dongle when the computer has a wireless screencasting function;
g) after the step f), the application capturing a screen of the computer and sends data of the screen to the dongle through the wireless screencasting connection;
h) after the step e), the application capturing a screen of the computer and sending data of the screen to the dongle through the wireless data connection when the computer does not have a wireless screencasting function; and
i) after the step g) or h), the dongle sending the data of the screen to the monitor.

2. The method of claim 1, wherein the wireless data connection is Wi-Fi.

3. The method of claim 1, wherein the step a) is performed through a VGA (Video Graphics Array) or HDMI (High-Definition Multimedia Interface) connector.

4. The method of claim 1, wherein the wireless screencasting function is a Miracast, Wi-Di (Wireless Display) or Screen Mirroring standard.

5. The method of claim 1, wherein the steps e) to h) are performed automatically.

6. The method of claim 1, wherein the steps e) to h) are performed manually.

7. The method of claim 6, wherein the application shows a menu of options on a display of the computer for being operated.

8. A method for wirelessly connecting a computer to a monitor, comprising the steps of:
a) connecting a dongle to a monitor;
b) creating a wireless data connection between the dongle and a computer;
c) the dongle sending an application to the computer;
d) the computer running the application;
e) the application detecting the computer;
f) creating a wireless screencasting connection between the computer and the dongle when the computer has a wireless screencasting function and the wireless screen casting function is selected to execute;
g) after the step f), the application capturing a screen of the computer and sends data of the screen to the dongle through the wireless screencasting connection;
h) after the step e), the application capturing a screen of the computer and sending data of the screen to the dongle through the wireless data connection when the computer does not have a wireless screencasting function or the wireless screencasting function is selected to execute; and
i) after the step g) or h), the dongle sending the data of the screen to the monitor.

9. The method of claim 8, wherein the wireless data connection is Wi-Fi.

10. The method of claim 8, wherein the step a) is performed through a VGA (Video Graphics Array) or HDMI (High-Definition Multimedia Interface) connector.

11. The method of claim 8, wherein the wireless screencasting function is a Miracast, Wi-Di (Wireless Display) or Screen Mirroring standard.

12. The method of claim 8, wherein the steps e) to h) are performed manually.

13. The method of claim 12, wherein the application shows a menu of options on a display of the computer for being operated.
